(19) United States
(12) Patent Application Publication
(10) Pub. No.: US 2018/0080754 A1
(43) Pub. Date: Mar. 22, 2018

(54) INTERFEROMETER FOR MEASURING QUALITIES OF LARGE SIZE OBJECTS

(71) Applicant: Sie-Poon Chang, Taipei (TW)

(72) Inventor: Sie-Poon Chang, Taipei (TW)

(21) Appl. No.: 15/270,004

(22) Filed: Sep. 20, 2016

(51) Int. Cl. G01B 9/02; G02B 27/14; G02B 19/00

(52) U.S. Cl. CPC G01B 9/02049; G02B 27/14; G01B 9/02015; G02B 19/0076; G02B 19/0028

(57) ABSTRACT

A laser pencil beam passes through a part of an interferometer and becomes two coherent laser pencil beams. These two laser pencil beams are aligned to pass a high magnification converging lens and become two diverging conic spherical waves. The beam coverage of these two diverging conic spherical waves becomes larger and larger as they travel. After a predetermined distance, the beam coverage of these two conic spherical waves could be as large as several meters. The conic spherical waves change their shapes and phases of wave fronts as they transmitted through (or reflected by) an optical object under test. By observing and analyzing the interference pattern of these two conic spherical waves, one can find out the quality of the object under test. This interferometer provides a way to test optical objects as large as several meters, as compare to several inches in diameter for the prior art interferometers.

### FIELD OF THE INVENTION

The present invention relates to interferometers, and in particular to an interferometer for measuring qualities of large size objects.

### BACKGROUND OF THE INVENTION

For a prior art interferometer for measuring the quality of an object by using the testing results of the interference pattern of two collimating beams contains the following elements.

In the prior art, one of the reflecting mirrors is a mirror under test for testing the optical quality of the sample. In practical measurement, another high quality mirror is used as the reference mirror for deriving a standard interference pattern. In the prior art, sizes of the mirrors under testing are strictly confined by the sizes of the whole structure, including the sizes of the beam splitter, a mirror under test, and a high quality mirror as a reference mirror so that sizes of the mirrors under testing are always smaller than the beam splitter.

Referring to FIGS. 1 and 2, a prior art interferometer includes the following elements.

A platform 100′ serves for locating other optical elements of the prior art.

A laser source 10′ for emitting a laser beam 90′ is located on the platform 100′ and is supported by a first angle adjusting device 15′ for adjusting a yaw angle and a pitch angle of the laser source so as to adjust the direction of the laser beam 90′ emitting from the laser source to a desired position. In this prior art structure, the laser beam 90′ has passed through a beam expander 60′ and becomes a collimated laser beam.

A beam splitter 20′ receives the laser beam 90′ from the laser source, then transmits part of the incident laser beam 90′ and reflects other part of the laser beam 90′. The beam splitter 20′ comprises of a plane optics (which partially transmits and partially reflects the incident light beam for directing the beam into two beams propagating in different directions). An angle between the surface of the plane optics 21′ and the incident laser beam 90′ is about 45 degrees. Usually, in the beam splitter, 50% of the incident laser beam 90′ is transmitted as beam 93′ and 50% of the incident laser beam 90′ is reflected as beam 91′. The beam splitter 20 is supported by a second angle adjusting device 25′ for adjusting a pitch angle, a yaw angle and a roll angle of the beam splitter 20′ so as to adjust the directions of the reflecting and transmitting laser beams.

A first reflecting mirror 30′ serves to receive the laser beam 91′ reflected through the beam splitter 20′. The first reflecting mirror 30′ is supported by a third angle adjusting device 35′ for adjusting pitch and yaw angles of the first reflecting mirror so as to direct the incident laser beam 91′ back to the beam splitter 20′.

The laser beam 92′ reflected from the first reflecting mirror 30′ will be incident to the beam splitter 20′ and then a part of the laser beam from the first reflecting mirror 30′ will transmit through the beam splitter 20′ as a first transmitting laser beam 96′.

In above preferable example, 50% of the reflected laser beam from the first reflecting mirror transmits through the beam splitter 20′. The intensity of laser beam 96′ is 25% of laser beam 90′.

A mirror under test 40′ is a reflecting mirror which reflect the laser beam 93′ transmitted through the beam splitter 20′. This second reflecting mirror 40′ is supported by a fourth angle adjusting device 45′ for adjusting pitch and yaw angles of the second reflecting mirror 40′ so as to direct the laser beam 93′ back to the beam splitter 20′ as beam 94′.

The laser beam 94′ reflected from the second reflecting mirror 40′ will incident to the beam splitter 20′ and then a part of the laser beam 94′ from the second reflecting mirror 40′ will be reflect by the beam splitter 20′ as a second transmitting laser beam 98′.

In above preferable example, 50% of the reflected laser beam 94′ from the second reflecting mirror 40′ transmits through the beam splitter 20′. Therefore only one fourth of the laser beam 90′ emitted from the laser source 10′ and reflected from the second reflecting mirror 40′ transmits through the beam splitter 20′ as beam 98′.

In above structure, as the first and second transmitting laser beams 96′, 98′ are coherent, these two transmitting laser beams 96′, 98′ will interfere with each other so as to present an interference pattern on a screen 70′.

In this prior art, because the laser beam 90′ emitting from the laser source 10′ is a collimated beam, which has a cross section as large as, for example, 4 inches in diameter so as to match the sizes of the object under test, the transmitting laser beams 96′, 98′ are collimated light beams so that the interference pattern does not be enlarged. It only confines in a small coverage. As a result, the size of the object under test 40′ is limited to be smaller than the size of the collimated beam. Therefore, the prior structure is only used to test finite sizes which are confined to the size of the collimated beam.

In many applications, it is desired that the mirrors under test have large sizes which are over the coverage of the interferometers of the prior arts. As a result, the prior art interferometer cannot be used to test the quality of a large mirror or a large lens. This is troublesome to the field and industry.

In present invention, several optical parts have been changed, so that the laser beam can cover a much larger area, and people can test optical components with diameters up to 70 inches. This kind of interferometer is useful in testing large optical components, such as astronomic telescopes, bird watcher telescopes, high power laser focusing mirrors, semiconductor wafers, large size display cover glasses, etc.

### SUMMARY OF THE INVENTION

Accordingly, the object of the present invention is to provide a interferometer for measuring qualities of large size optical objects, wherein in the present invention, projecting conic spherical waves can cover a very large area which may be several tens or hundreds larger than the prior art in size. The present invention can be used to test a very large object, even to six feet diameter or bigger ones, while the prior art only tests mirrors having a size of several inches. Furthermore, the present invention can be used to test both transmitting objects (i.e., lenses and windows) and reflecting objects (i.e., mirrors and semiconductor wafers.)

To achieve above object, the present invention provides an interferometer for measuring qualities of large size objects comprising: a platform; a laser source for emitting a laser pencil beam being located on the platform; a beam splitter for receiving the laser pencil beam from the laser source; transmitting part of the incident laser pencil beam and reflecting other part of the laser pencil beam; the beam splitter comprising an optics (which partially transmits and partially reflects the incident light beam for directing the beam into two beams propagating in different directions); an angle between a surface of the plane optics and the incident laser pencil beam being about 45 degrees; a first high quality plane reflecting mirror for receiving the laser pencil beam reflected from the beam splitter; the laser pencil beam reflected from the first reflecting mirror will be sent back to the beam splitter and then a part of the laser pencil beam from the first reflecting mirror will transmit through the beam splitter as a first transmitting laser pencil beam; a second high quality reflecting plane mirror for receiving the laser pencil beam transmitted through the beam splitter; the laser pencil beam reflected from the second reflecting mirror will also be sent back to the beam splitter and then a part of the laser pencil beam from the second reflecting mirror will transmit through the beam splitter as a second transmitting laser pencil beam; a focusing lens for receiving the first and second transmitting laser pencil beams and then focuses these two laser pencil beams on the focal plane of the focusing lens; after the first and second transmitting laser beams pass through the focal plane, these two focused beams propagate forward as two conic diverging spherical waves; coverage of these two conic diverging spherical waves become larger and larger with propagation path thereof; after a predetermined length, the coverage is larger than the case without using a focusing lens; therefore it can cover a large object under test as desired; a measuring screen located before or behind the object under test; wherein if the transmitting conic spherical wave transmit through the object, the measuring screen being located behind the object under test, while if the object under test is a reflecting object, the measuring screen is located before the object under test; and wherein the transmitting conic spherical waves pass through or being reflected by the object under test, the conic spherical waves will be further incident to a measuring screen and then present an interference pattern thereon; if the object under test is a perfect one, the interference pattern is also perfect as a theoretical one, while if the object under test is not perfect, the interference pattern is distorted as an imperfect one; as a result, the interference pattern on the screen is used to evaluate the perfectness of the object under test.

The various objects and advantages of the present invention will be more readily understood from the following detailed description when read in conjunction with the appended drawings.

### BRIEF DESCRIPTION OF THE DRAWINGS

FIG. 1 is a schematic view showing the arrangement of the components of the interferometer according to the prior art, where the object under test is a light reflecting object, i.e., a plane mirror.

FIG. 2A shows the propagation and interference of the collimated beams along the structure shown in FIG. 1.

FIG. 2B shows the optical paths of the collimated beam.

FIG. 3 is a schematic view showing the arrangement of the components of the interferometer according to the present invention, where the object under test is a light reflecting surface.

FIG. 4 is a schematic view showing another arrangement of the components of the interferometer according to the present invention, where the object under test is a light transmitting lens.

FIG. 5 shows the optical paths along the structure shown in FIG. 3.

FIG. 6 shows the optical paths along the structure shown in FIG. 4.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

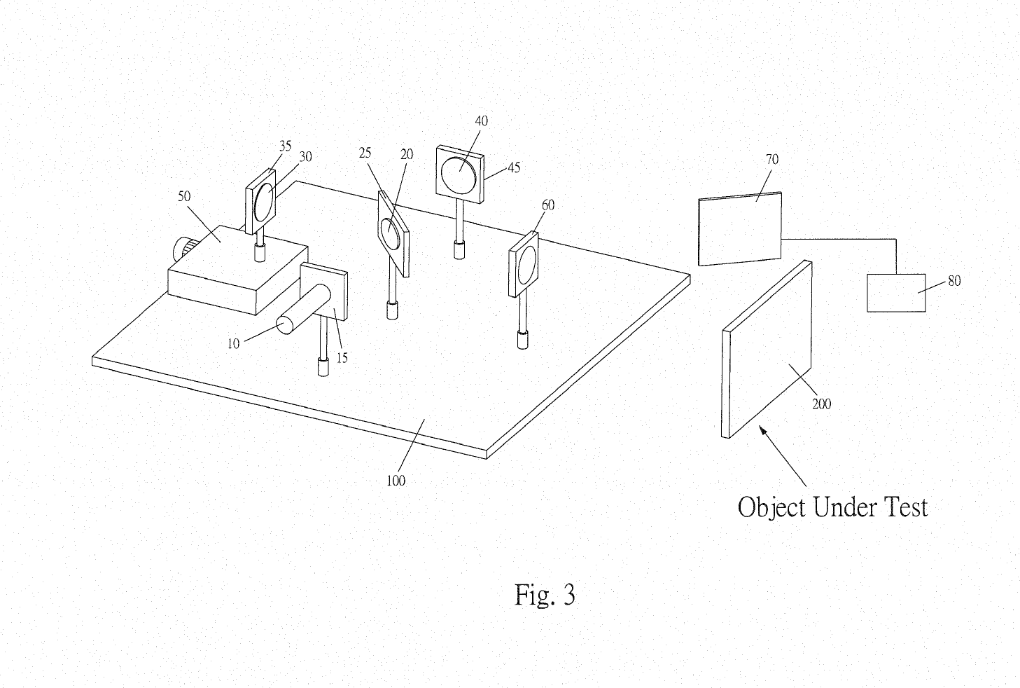

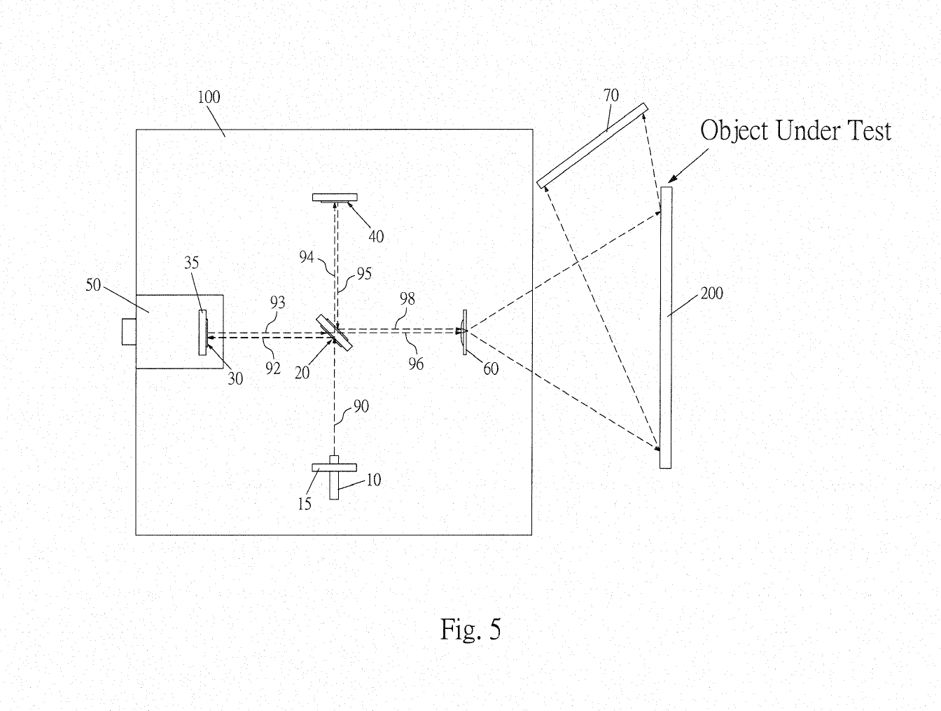

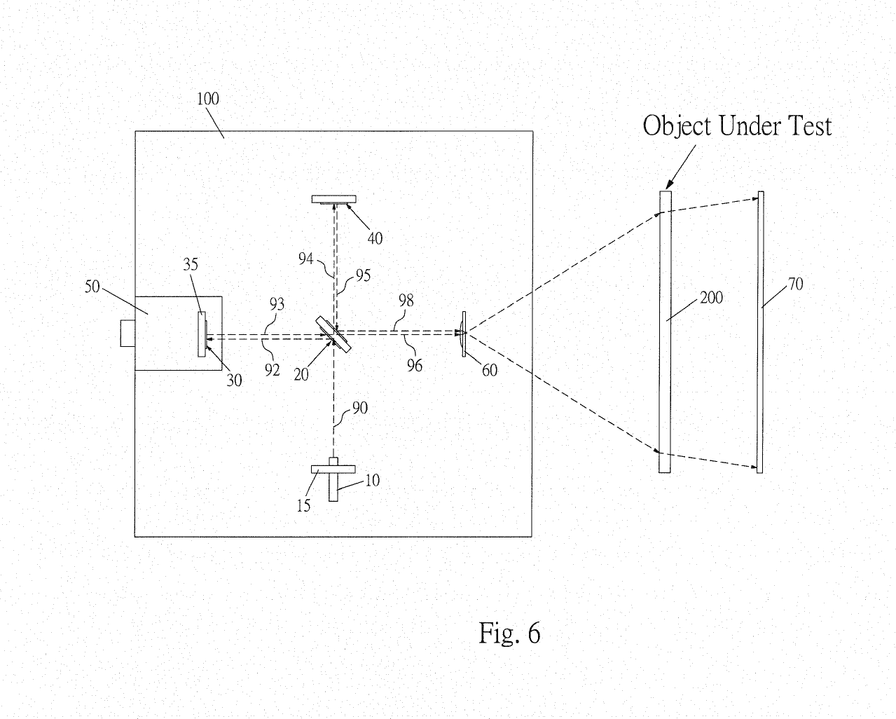

Referring to FIGS. 3 to 6, the interferometer for measuring qualities of large size objects according to the present invention is illustrated. The structure of the interferometer for measuring qualities of large size objects comprises the following elements.

A platform 100 serves for locating other optical elements of the present invention.

A laser source 10 for emitting a laser pencil beam 90 is located on the platform 100 and is supported by a first angle adjusting device 15 for adjusting a yaw angle and a pitch angle of the laser source so as to adjust a direction of the laser pencil beam 90 emitting from the laser source to a desired object. As compare to using a collimated beam in the prior arts, laser pencil beams are being used as a laser source of the interferometer.

A beam splitter 20 receives the laser pencil beam 90 from the laser source 10, then transmits a part of the laser pencil beam 90 and reflects the remaining part of the laser pencil beam 90. The beam splitter 20 comprises a plane optics 21 (which partially transmits and partially reflects the incident light beam for directing the beam into two beams propagating in different directions). An angle between the surface of the plane optics 21 and the incident laser pencil beam 90 is about 45 degrees.

Preferably 50% of the incident laser pencil beam 90 is transmitted and 50% of the incident laser pencil beam 90 is reflected by the beam splitter 20.

The beam splitter 20 is supported by a second angle adjusting device 25 for adjusting a pitch angle, a yaw angle and a roll angle of the beam splitter 20 for adjusting the directions of the reflecting and transmitting laser pencil beams.

A first reflecting mirror 30 serves to receive the laser pencil beam 92 reflected from the beam splitter 20. The first reflecting mirror 30 is supported by a third angle adjusting device 35 for adjusting pitch and yaw angles of the first reflecting mirror so as to direct the incident laser pencil beam 92 back to the beam splitter 20.

The laser pencil beam 93 reflected from the first reflecting mirror 30 will be incident to the beam splitter 20 and then a part of the laser pencil beam from the first reflecting mirror 30 will transmit through the beam splitter 20 as a first transmitting laser pencil beam 96.

In above preferable example, 50% of the reflected laser beam 93 from the first reflecting mirror transmits through the beam splitter 20. Therefore only one fourth of the laser pencil beam 90 emitted from the laser source 10 and reflected from the first reflecting mirror 30 transmits through the beam splitter 20.

A second reflecting mirror 40 serves to receive the laser pencil beam 94 transmitted from the beam splitter 20. The second reflecting mirror 40 is supported by a fourth angle adjusting device 45 for adjusting pitch and yaw angles of the second reflecting mirror 40 so as to direct the incident laser pencil beam 94 back to the beam splitter 20.

The laser pencil beam 95 reflected from the second reflecting mirror 40 will be incident to the beam splitter 20 and then a part of the laser pencil beam 95 from the second reflecting mirror 40 will reflect from the beam splitter 20 as a second transmitting laser pencil beam 98.

In above preferable example 50% of the laser pencil beam 95 reflected from the second reflecting mirror 40 will be reflected from the beam splitter 20. Therefore only one fourth of the laser pencil beam 90 emitted from the laser source 10 and reflected from the second reflecting mirror 40 reflects through the beam splitter 20.

A translation stage 50 is installed to one of the first and second reflecting mirrors. In this drawing, the translation stage 50 is installed to the first reflecting mirror 30. However, the translation stage 50 may be installed to the second reflecting mirror 40.

In the present invention, it is also permissible that both of the first and second reflecting mirrors 30, 40 are installed with translation stages 50, respectively.

The function of the translation stage 50 is to change a position of the first reflecting mirror 30 (or the second reflecting mirror 40) so as to change the optical path length of the corresponding reflecting laser pencil beam.

A focusing lens 60 installed in the propagating path of the first and second laser pencil beams 96, 98. As the first and second transmitting laser pencil beams 96 and 98 pass through the focusing lens 60, they focus on the focal plane of the focusing lens 60; after the first and second transmitting laser pencil beams 96, 98 pass through the focal plane, these two beams propagate forward as two conic spherical waves. Coverage of these two conic spherical waves becomes larger and larger with propagation path thereof. After a predetermined length, the coverage is larger than the case without using a focusing lens 60; therefore it can cover a large object under test as desired, the coverage could be several tens or hundreds larger than the case without using the focusing lens 60 as shown in above prior art.

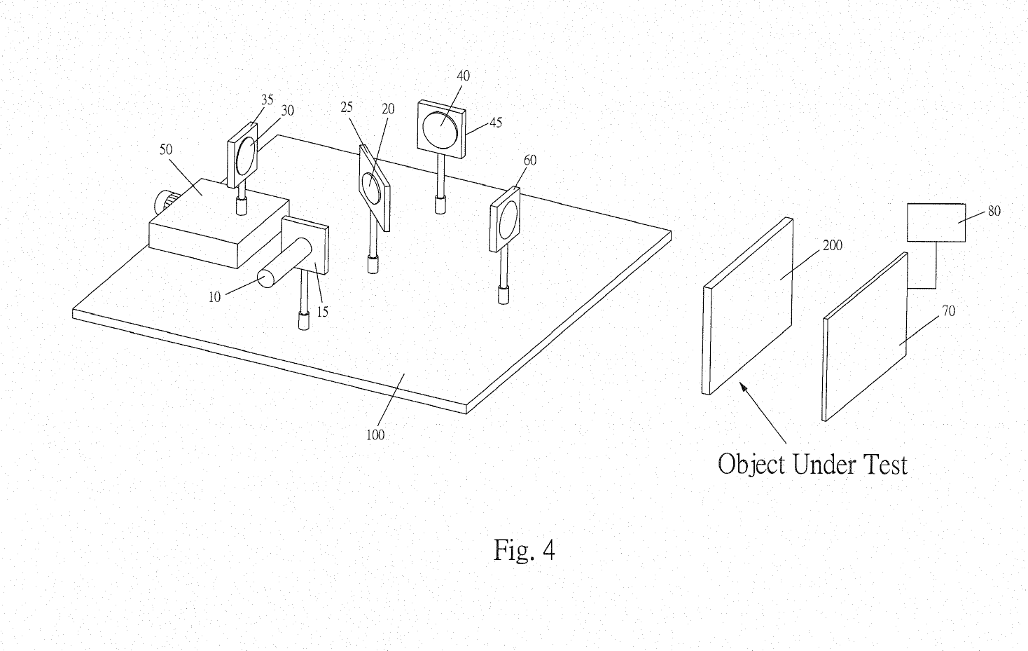

The present invention further includes a measuring screen 70 which is located beyond (see FIG. 3) or behind the object under test 200 (see FIG. 4).

After the transmitting laser beams 96, 98 pass through or reflected by the object under test 200, the laser beams 96, 98 will be further incident to a measuring screen 70 and then present an interference pattern thereon. If the object under test 200 is a perfect one, the interference pattern is also perfect as a theoretic one, while if the object under test 200 is imperfect, the interference pattern is also an imperfect one. As a result, the interference pattern on the screen is used to decide the perfectness of the object under test.

A pattern analysis device 80 includes a camera (not shown) to capture the interference pattern on the screen, and then calculates and outputs the parameters of the object under test.

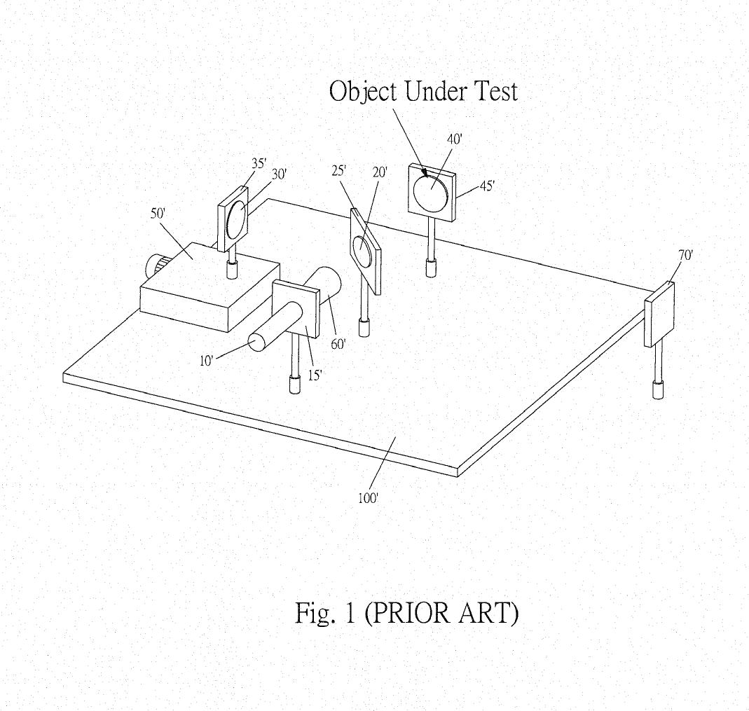

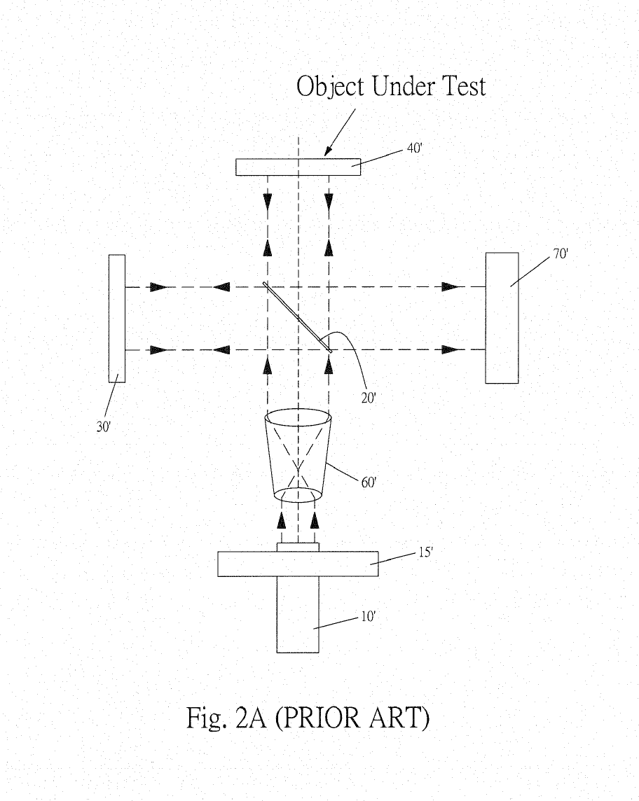

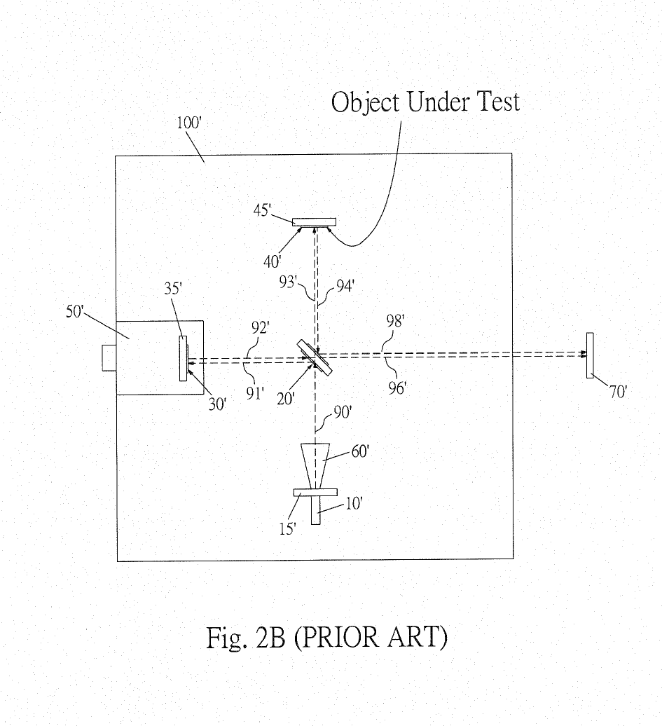

It should be noted that in the present invention, referring to FIGS. 1, 2 (for prior art) and 3 and 4 (for the present invention), the object under test 200 is located in a light path after the beam from the beam splitter transmits through the focusing lens 60 and far away from the focusing lens 60, while in the prior art, the object under test 40′ is at the position of the reflecting mirror 40′.

Furthermore, the present invention provides a focusing lens 60 so the beam coverage enlargement of the present invention is due to the divergence of the beams passing through the focusing lens 60, while the prior art as said in the background of the invention, has no focusing lens, so that the beams are always collimated, which keep their sizes in the propagation path. Due to this effect, the present invention can be used to measure large objects under test which has sizes larger than five, ten, or even one hundred times of the prior art.

Advantages of the present invention are that the projecting conic spherical waves can cover a very large area which may be several tens or hundreds larger than the prior art so that the present invention can be used to test a very large object (a transmitting or reflecting object), even to three meters in diameter or bigger ones, while the prior art only tests mirrors having a size of several inches, depending on the sizes of the optics in the structure.

The present invention is thus disclosed, it will be obvious that the same may be varied in many ways. Such variations are not to be regarded as a departure from the spirit and scope of the present invention, and all such modifications as would be obvious to one skilled in the art are intended to be included within the scope of the following claims.

1. An interferometer for measuring qualities of large size objects comprising:
a platform;
a laser source for emitting a laser beam being located on the platform;
a beam splitter for receiving the laser beam from the laser source;
transmitting part of the incident laser beam and reflecting other part of the laser beam; the beam splitter comprising a plane optics having two opposite planes; an angle between a surface of the plane optics and the incident laser beam being about 45 degrees;
a first reflecting mirror for receiving the laser beam reflected from the beam splitter; the laser beam reflected from the first reflecting mirror will be incident back to the beam splitter and then a part of the laser beam from the first reflecting mirror will transmit through the beam splitter as a first transmitting laser pencil beam;
a second reflecting mirror for receiving the laser beam transmitted through the beam splitter; the laser beam reflected from the second reflecting mirror will be incident back to the beam splitter and then a part of the laser beam from the second reflecting mirror will reflect from the beam splitter as a second transmitting laser pencil beam;
wherein if the first and second transmitting laser beams are coherent, the two transmitting laser beams will interfere with each other so as to present an interference pattern on a testing object located on the optical paths of the first and second transmitting laser beams;
a focusing lens for receiving the first and second transmitting laser beams and then focuses them on a focal plane of the focusing lens; after the first and second transmitting laser beams passes through the focal plane, they propagate as two conic spherical waves; coverage of two conic spherical waves become larger and larger with propagation path thereof; after a predetermined length, the coverage is larger than the case without using a focusing lens; therefore it can cover a large object as desired;
a measuring screen located before or behind the object under test; wherein if the transmitting laser beams transmit through the object, the measuring screen being located behind the object under test, while if the object under test is a reflecting object, the measuring screen is located before and aside the object under test; and
wherein the transmitting laser beams pass through or being reflected by the object under test, the laser beams will be further incident to the measuring screen and then present an interference pattern thereon; if the object under test is a perfect one, the interference pattern is also perfect as a theoretic one, while if the object under test is not a perfect one, the interference pattern is an imperfect one; as a result, the interference pattern on the screen is used to decide the perfectness of the object under test; and
wherein the first and second laser pencil beams propagate as two conic spherical waves, and a coverage of these two conic spherical beams is increased along propagation paths thereof; these two conic spherical waves are coherent since they come from the same laser source; these two conic spherical waves then interfere with each other along the propagation path and generate interference patterns all the way inside the space covered by both these two interfered conic spherical waves; the coverage of these two interfered conic spherical waves could be hundreds or thousands times of a diameter of the original first and second laser pencil beams, so that people can use this interferometer to test large objects of sizes up to a diameter of three meter or even larger.

2. The interferometer for measuring qualities of large size objects as claimed in claim 1, further comprising:
a pattern analysis device includes a camera to capture the interference pattern on the screen and then calculate and output parameters of the object under test.

3. The interferometer for measuring qualities of large size objects as claimed in claim 1, wherein the laser source is supported by a first angle adjusting device for adjusting a yaw angle and a pitch angle of the laser source so as to adjust a direction of the laser beam emitting from the laser source.

4. The interferometer for measuring qualities of large size objects as claimed in claim 1, wherein 50% of the incident laser pencil beam is transmitted through the beam splitter and 50% of the incident laser pencil beam is reflected from the beam splitter.

5. The interferometer for measuring qualities of large size objects as claimed in claim 1, wherein the beam splitter is supported by a second angle adjusting device for adjusting an pitch angle, a yaw angle and a roll angle of the beam splitter for fine-adjusting directions of the reflecting and transmitting laser pencil beams.

6. The interferometer for measuring qualities of large size objects as claimed in claim 1, wherein the first reflecting mirror is supported by a third angle adjusting device for adjusting pitch and yaw angles of the first reflecting mirror so as to direct the incident laser pencil beam back to the beam splitter.

7. The interferometer for measuring qualities of large size objects as claimed in claim 1, wherein the second reflecting mirror is supported by a fourth angle adjusting device for adjusting pitch and yaw angles of the second reflecting mirror so as to direct the incident laser pencil beam back to the beam splitter.

8. The interferometer for measuring qualities of large size objects as claimed in claim 1, wherein a translation stage is installed to one of the first and second reflecting mirrors; and a function of the translation stage is to change a position of the first reflecting mirror or the second reflecting mirror so as to change an optical path length of the reflecting laser pencil beam.
